(19) United States
(12) Patent Application Publication
(10) Pub. No.: US 2014/0207974 A1
(43) Pub. Date: Jul. 24, 2014

(54) SYSTEMS AND METHODS FOR MANAGING COMMUNICATION DEVICE CAPABILITIES

(71) Applicant: TATA CONSULTANCY SERVICES LIMITED, Mumbai (IN)

(72) Inventor: Srinivasan PULIPAKKAM, Sunnyvale, CA (US)

(21) Appl. No.: 13/851,312

(22) Filed: Mar. 27, 2013

(30) Foreign Application Priority Data
Jan. 19, 2013 (IN) 180/MUM/2013

(51) Int. Cl. G06F 9/44

(52) U.S. Cl. CPC G06F 9/4411
USPC 710/11

(57) ABSTRACT

The present subject matter discloses a method for managing capabilities of a communication device. In one implementation, the method comprises communicating, by the communication device, with a stationary device provided at a predetermined location using a short distance communication protocol. The method further comprises obtaining one or more device management policies associated with the predetermined location. The method further comprises implementing the device management policies for controlling usage of one or more capabilities of the communication device at the predetermined location.

### TECHNICAL FIELD

The present subject matter relates, in general, to communication devices and, in particular, to a system and a method for dynamic management of communication device capabilities.

### BACKGROUND

With the advent in technology, there has been a vast improvement in capabilities and features of communication devices, thus leading to an increase in associated usages of the communication devices. For example, the communication devices, such as smart phones are capable of recording images, videos and sound; transferring and receiving files anywhere anytime over a communication network, and playing audio. Managing usage of such communication devices is therefore desirable to various enterprises and organizations, such as research labs and technology firms. The organizations may wish to manage the communication devices for various reasons, such as implementing restrictions, partial or complete, on usage of few capabilities of the communication devices within their complexes. For example, the research labs may wish to restrict usage of cameras and other communication capabilities of the communication devices to avoid leakage of sensitive data related to their work. Similarly, few organizations, although not much concerned about the usage of the communication devices in their complex, may desire the communication devices to be put on a silent mode in meeting areas and conference rooms.

Thus, owing to the various needs, the organizations may either monitor the usage of the communication devices in restricted areas, such as the conference rooms where the usage needs to be managed or employ device management policies restricting usage of certain capabilities of the communication devices throughout their complex. Further, owing to the difficulty in managing the communication devices with multiple functionalities, the organizations may even completely restrict usage of such communication devices, thus affecting the employees of such organizations.

### SUMMARY

This summary is provided to introduce concepts related to systems and methods for managing communication device capabilities. These concepts are further described below in the detailed description. This summary is not intended to identify essential features of the claimed subject matter nor is it intended for use in determining or limiting the scope of the claimed subject matter.

In one embodiment, the method for managing capabilities of a communication device is provided. In one implementation, the method comprises communicating, by the communication device, with a stationary device provided at a predetermined location using a short distance communication protocol. The method further comprises obtaining one or more device management policies associated with the predetermined location. The method further comprises implementing the device management policies on the communication device for controlling usage of one or more capabilities of the communication device at the predetermined location.

### BRIEF DESCRIPTION OF THE DRAWINGS

The detailed description is described with reference to the accompanying figure(s). In the figure(s), the left-most digit(s) of a reference number identifies the figure in which the reference number first appears. The same numbers are used throughout the figure(s) to reference like features and components. Some embodiments of systems and/or methods in accordance with embodiments of the present subject matter are now described, by way of example only, and with reference to the accompanying figure(s), in which:

FIG. 1 illustrates components of a communication device, according to an embodiment of the present subject matter.

FIG. 2 illustrates a network environment implementing a communication device in communication with a device management system and a stationary device, in accordance with a first embodiment of the present subject matter

FIG. 3 illustrates a network environment implementing the communication device in communication with a stationary device configured to function as the device management system, in accordance with a second embodiment of the present subject matter.

FIG. 4 illustrates a method for implementing device managing policies for managing capabilities of a communication device, in accordance with an embodiment of the present subject matter.

FIG. 5 illustrates a method for providing device managing policies to a communication device for managing capabilities of the communication device, in accordance with the first embodiment of the present subject matter.

FIG. 6 illustrates a method for providing device managing policies to a communication device for managing capabilities of the communication device, in accordance with the second embodiment of the present subject matter.

### DETAILED DESCRIPTION

In recent years, capabilities of communication devices have increased multifold thus enabling a user of the communication device to perform various tasks using a single communication device. For instance, the communication devices, such as smart phones include inbuilt cameras and mobile network connectivity supports allowing users to record images, video and sound, and transfer the recordings to other devices over mobile network. Recording of such images, video and sound may, however, be subject to copyright or confidentiality issues in certain locations, for example, in concerts, art museums, research laboratories, and military areas. Similarly, mobile network connectivity may not be desired in places, such as hospitals where the mobile network connectivity may result in interference with medical equipments. Further, audio playing capabilities, such as music players and ring tone playback of the communication devices may not be desired in organizations like hospitals, educational institutes, and offices.

Such organizations may thus desire to be able to restrict the communication devices in their capabilities or conditionally allow the communication devices to use their capabilities. Managing usage of the communication devices, however, has been an issue of concern for various enterprises and organizations. The organizations thus typically issue device management policies regarding usage of the communication devices in their complex. The device management policies, as will be understood, may define what all capabilities of the communication device need to be restricted at different places in the organization's complex, based on which employees may manually adjust their communication devices to turn off their communication device's capabilities in accordance with the device management policies. Manual implementation of the device management policies may, however, not be effective as the employees may, intentionally or by mistake, fail to turn off the capabilities of the communication devices in accordance to the device management policies.

One conventional technology includes usage of mobile jammers in the organization's complex, thus providing a blanket ban on the usage of the communication devices. The blanket ban, however, may not be useful in the organizations where only few capabilities of the communication devices need to be restricted and that too at only few places in the complex.

Another conventional technology for managing the communication device capabilities includes implementing the device management policies using global positioning system (GPS) technology. In said technology, the device management policy may be implemented on the communication device based on a location of the employee's communication device identified using the GPS technology. However, using the GPS to identify the location of the communication devices may not be effective in places having no or very low wireless network connectivity, like in basements. Further, the GPS may not be effective in determining the location indoors, thus affecting the implementation of the device management policies.

In accordance with the present subject matter, systems and a computer-implemented method for managing communication device capabilities of a communication device are described. The systems are configured to dynamically manage the communication device capabilities based on a location of the communication device. For instance, the systems may be configured to restrict usage of a camera of the communication device in certain predetermined areas of an organization's complex. The systems and methods can be implemented in a variety of computing devices. The computing devices include, but are not limited to, desktop computer, hand-held devices, mobile phones, smart phones, cloud servers, mainframe computers, workstation, multiprocessor system, laptop computer, network computer, minicomputer, server, and the like. Further, the communication devices include, but are not limited to, hand-held devices, mobile phones, smart phones, and the like.

In accordance with the present subject matter, the communication device may be provided with a policy implementation application configured to implement device management policies received from a device management system. In one implementation, a user of the communication device, while entering a predetermined location where certain capabilities of the communication device need to be restricted, may bring the communication device in contact with a stationary device located at the predetermined location. For instance, the stationary device may be stationed at an entrance of the predetermined location, say, a conference room of an organization. The communication device, upon the contact, may communicate with the stationary device using one or more short range communication protocols, such as NFC, Bluetooth, and device contact application. The device contact application may be defined as a communication protocol using which two communication devices may communicate with each other by way of a physical contact. A communication device in such a case may initiate data transfer with another communication device upon detecting a physical touch with the other communication device. Based on the communication with the stationary device, the communication device may subsequently obtain one or more device management policies corresponding to location coordinates of the predetermined location.

According to a first embodiment of the present subject matter, the device management system may be a server communicating with the communication device over a wireless network. In said embodiment, the stationary device may be configured to determine a location of the communication device based on the communication with the communication device over a short range communication protocol, such as near field communication (NFC), Bluetooth, device contact application, ultrasound technology, and a quick response (QR) code scanning technology. The communication, in one implementation, may include exchanging an interaction message between the stationary device and the communication device based on which the stationary device may ascertain that the communication device is in its vicinity and thus, has same location coordinates as the device management system. Subsequently, the stationary device may provide the location coordinates of the predetermined location to the communication device. In another implementation, the communication may include obtaining, as an interaction message, a scanned image of a QR code taken by a scanning application installed in the communication device. The QR code may be further used by the communication device to determine the location coordinates of the QR code and hence the communication device.

The communication device may subsequently provide the location coordinates to the device management system over the wireless network. The device management system, upon receiving, the location coordinates, may ascertain the device management policies associated with the location coordinates and provide them to the communication device.

According to a second embodiment of the present subject matter, the stationary device may be configured to function as a device management system and stationed at the predetermined location. In one implementation, the stationary device may be an NFC enabled device. In another implementation, the stationary device may be a Bluetooth enabled device. In yet another implementation, the stationary device may be enabled to interact using a device contact application. The communication device, on coming in contact with stationary device may exchange the interaction message with the stationary device using the short communication protocol. The stationary device may thus ascertain based on the interaction message that the communication device is in its vicinity and has same location coordinates as the stationary device. Based on the ascertaining, the stationary device may obtain the device management policy associated with the location coordinates. In one implementation, the device management policy may be stored within the stationary device itself. The device management policy thus obtained may be transmitted to the communication device using the short communication protocol, such as the NFC protocol, the Bluetooth protocol, and the device contact application.

Subsequently, the device management policies may be implemented by the policy implementation application for managing the capabilities of the communication device in the predetermined location. For instance, in case of the predetermined location being a conference room, the device management policies may require the communication device to be on a silent profile and the camera of the communication device to be disabled. The policy implementation application may thus set the communication device on the silent profile and disable the camera.

The present subject matter thus provides systems and methods for managing capabilities of a communication device based on the location of the communication device. Providing the stationary device enabled to communicate with the communication device over the short range protocol at the predetermined location ensures a correct identification of the location of the communication device for ascertaining the device management policies. Further, enabling the stationary device to store and provide the device management policy in places with no wireless network availability helps in implementation of the present subject matter at both indoor and outdoor locations.

These and other advantages of the present subject matter would be described in greater detail in conjunction with the following figures. While aspects of described systems and methods for dynamic management of communication device capabilities can be implemented in any number of different computing systems, environments, and/or configurations, the embodiments are described in the context of the following exemplary system(s).

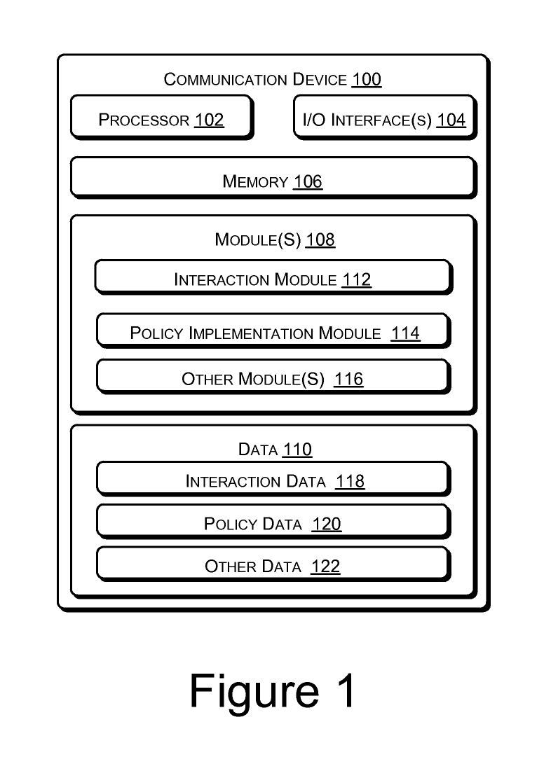

FIG. 1 illustrates various components of a communication device 100, configured to dynamically manage its capabilities in a predetermined location based on the one or more device management policies associated with the predetermined location, according to an embodiment of the present subject matter. Examples of the communication device 100 include, but are not limited to, personal digital assistants, smart phones, hand held devices, mobile phones, and the like. In said embodiment, the communication device 100 includes one or more processor(s) 102, I/O interface(s) 104, and a memory 106 coupled to the processor(s) 102. The processor(s) 102 may be implemented as one or more microprocessors, microcomputers, microcontrollers, digital signal processors, state machines, logic circuitries, and/or any devices that manipulate signals based on operational instructions. Among other capabilities, the processor(s) 102 are configured to fetch and execute computer-readable instructions and data stored in the memory 106.

The functions of the various elements shown in the figure, including any functional blocks labeled as “processor(s)”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, network processor, application specific integrated circuit (ASIC), field programmable gate array (FPGA), read only memory (ROM) for storing software, random access memory (RAM), non-volatile storage. Other hardware, conventional and/or custom, may also be included.

The I/O interface(s) 104 may include a variety of software and hardware interfaces, for example, interface for peripheral device(s), such as a keyboard and an external memory. Further, the I/O interface(s) 104 may enable the communication device 100 to communicate over a network, for example, a short range communication network and a wireless communication network. The I/O interface(s) 104 may include one or more ports for connecting the communication device 100 with other computing devices, such as web servers and external databases. The I/O interface(s) 104 may facilitate multiple communications within a wide variety of protocols and networks, such as a network, including short range communication, e.g., NFC, Bluetooth, device contact application, ultrasound technology, and a QR code scanning technology, and wireless networks, e.g., WLAN, cellular, satellite, etc.

The memory 106 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, and optical disks. The communication device 100 also includes module(s) 108 and data 110.

The module(s) 108 include routines, programs, objects, components, data structures, etc., which perform particular tasks or implement particular abstract data types. The module(s) 108 include an interaction module 112, a policy implementation module 114, and other module(s) 116. The other module(s) 116 may include programs or coded instructions that supplement applications and functions, for example, programs in the operating system of the communication device 100.

The data 110 serves, amongst other things, as a repository for storing data processed, received, and generated by one or more of the module(s) 108. The data 110 includes interaction data 118, policy data 120, and other data 122. The other data 122 includes data generated as a result of the execution of one or more other modules 116.

As previously described, the communication device 100 is configured to dynamically manage its capabilities in a predetermined location based on the corresponding device management policies. For instance, when used by an employee of an organization, the communication device 100 may be configured to implement at different locations of the organization's premises, the device management policies associated with these locations as and when the employee enters these locations along with the communication device 100. For example, in an office premises different device management policies may be applied at different floors or different areas on similar floors. The device management policy associated with a conference room may be defined to have the communication device 100 in silent mode, while the device management policy associated with a research lab of the organization may be defined to have a camera (not shown in this figure) of the communication device 100 disabled. Further, the device management policies may also vary depending upon the position of the employee corresponding to the communication device 100. For example, while entering the research lab, scientists working in the research laboratories may be allowed to have the camera enabled, while other employees of the organization may need to disable the camera. The communication device 100 may thus be required to implement the varying device management policies as and when the communication device 100 enters the corresponding location.

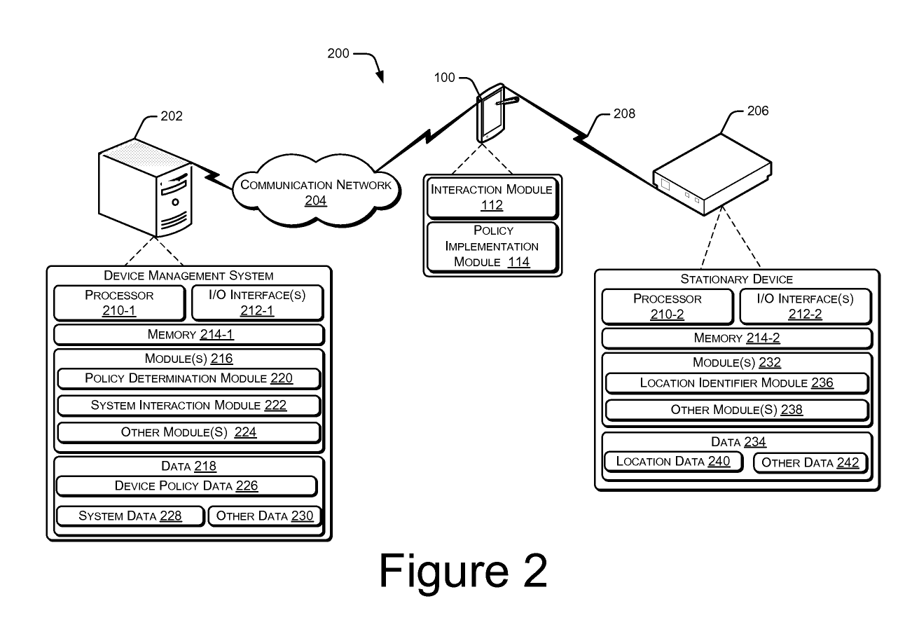

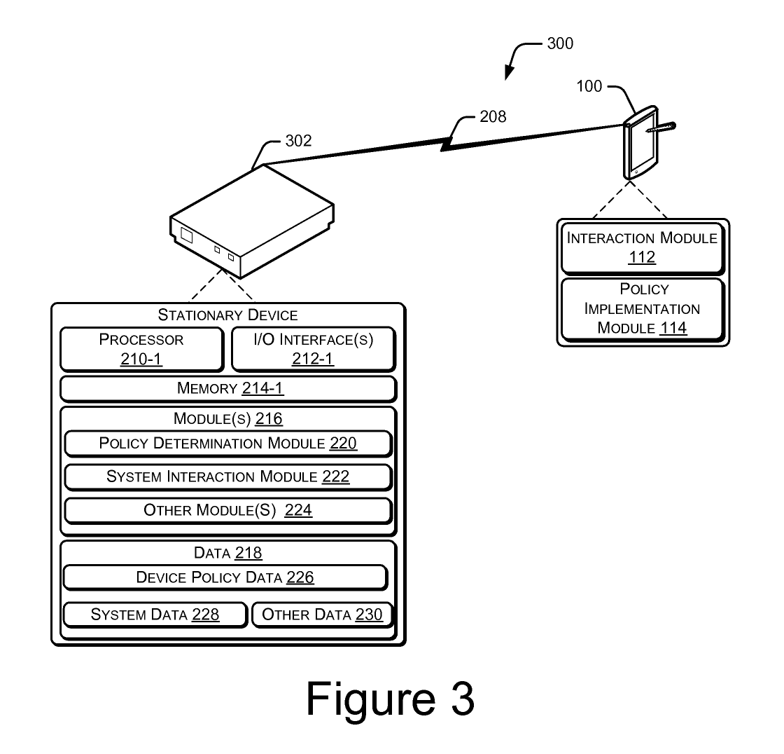

In accordance with the present subject matter, the communication device 100 may be configured to receive the device management policies from a device management system (not shown in this figure). In one implementation, a user of the communication device 100, while entering the predetermined location where certain capabilities of the communication device 100 needs to be restricted, may bring the communication device 100 in contact with a stationary device (not shown in this figure) located at the predetermined location. In one implementation, the stationary device, as will be explained in greater details in relation to FIGS. 2 and 3, may be understood as any device capable of storing data, such as location coordinates of the predetermined location or the device management policies corresponding to the predetermined location. In another implementation, the stationary device, as will be explained in greater details in relation to FIGS. 2 and 3, may be understood as any device having processing capabilities, such as identifying location coordinates of the predetermined location, and storing data, such as the location coordinates and the device management policies corresponding to the predetermined location. Further, the stationary device may be capable of communicating with the communication device 100 using one or more short range communication protocols, such as NFC, Bluetooth, ultrasound technology, and device contact application. Examples of the stationary device include, but are not limited to, an ultrasound beacon, an NFC enabled device, a Bluetooth enabled device, a device contact application enabled device, and a QR code enabled device.

Upon coming in contact with the stationary device, the interaction module 112 may communicate with the stationary device using any one of the short range communication protocol. In one embodiment, the interaction module 112 may exchange an interaction message with the stationary device. For instance, in case of the stationary device having processing capabilities, the interaction message may include device identification details, such as an IP address of the communication device 100 or the stationary device, as will be explained in greater details in respect to FIGS. 2 and 3. In another embodiment, in case of the stationary device having only storage capabilities, for example, in case of the QR code or the ultrasound beacon, the interaction module 112 may communicate with the stationary device by taking a photo or scanning the QR code or using sound codes produced by the ultrasound beacon. The interaction module 112 may subsequently save data exchanged during the communication in the interaction data 118.

Subsequently, the policy implementation module 114 may obtain one or more device management policies corresponding to the predetermined location based on the communication with the stationary device. In a first embodiment, with the device management system being a server communicating with the communication device 100 over a wireless network, the policy implementation module 114, may initially obtain location coordinates of the predetermined location from the stationary device. The policy implementation module 114, may subsequently transfer the location coordinates to the device management system based on which the device management system may provide the device management policies associated with the predetermined location corresponding to the location coordinates.

In a second embodiment, the stationary device maybe configured to function as the device management system capable of interacting with the communication device 100 using the short range communication protocol, such the NFC protocol or the Bluetooth protocol. The stationary device may provide the device management policies corresponding to the predetermined location upon establishing the communication with the communication device 100.

The policy implementation module 114 may subsequently implement the device management policies to restrict few of its capabilities in the predetermined location as defined in the device management policies. The policy implementation module 114, may further save the device management policies in the policy data 120. Further, while moving out of the predetermined location, the policy implementation module 114 may remove the restrictions on the capabilities, for example, upon a communication between the interaction module 112 and the stationary device. In one implementation, upon the interaction, the policy implementation module 114 may initially determine the device management policies corresponding to the location coordinate of the stationary device using the process as previously explained. Upon obtaining the device management policies, the policy implementation module 114 may determine whether the device management policies have been already implemented on the communication device 100. In case the particular device management policy is already applied on the communication device 100 then the device management policies are toggled to remove the restrictions applied on the communication device 100. For instance, if the communication device 100 is already in silent mode, a scan of the QR Code again will toggle the communication device 100 back to non-silent mode.

Further, the working of the communication device 100, the device management system, and the stationary device in accordance to the first embodiment, the second embodiment, and the third embodiment will be explained in greater details in relation with the FIGS. 2 and 3.

FIG. 2 illustrates a network environment 200 implementing the communication device 100 in communication with the device management system and the stationary device, in accordance with the first embodiment of the present subject matter. In said embodiment, the device management system 202 has been provided as a server communicating with the communication device 100 over a communication network 204. As The device management system 202 is configured to provide the device management policies to the communication device 100 based upon the location coordinates provided by the communication device 100. In one implementation, the location coordinates are determined by a stationary device 206 communicating with the communication device 100 over a short range communication link 208 using the short range communication protocols, such as the NFC, the Bluetooth, the device contact application, the QR code scanning technology, and the ultrasound technology.

The communication network 204 may be a wireless network, or a combination of wired and wireless network. The communication network 204 can be a collection of individual networks, interconnected with each other and functioning as a single large network (e.g., the internet or an intranet). Examples of such individual networks include, but are not limited to, 3rd Generation Partnership Project (3GPP), Long Term Evolution (LTE), Global System for Mobile Communication (GSM) network, Universal Mobile Telecommunications System (UMTS) network, Time Division Multiple Access (TDMA) network, Code Division Multiple Access (CDMA) network, Next Generation Network (NGN), and Integrated Services Digital Network (ISDN). The communication networks 204 may be any public or private network, including a local area network (LAN), a wide area network (WAN), the Internet, an intranet, a peer to peer network, and a virtual private network (VPN) and may include a variety of network devices, such as routers, bridges, servers, computing devices, storage devices, etc.

The device management system 202 can be implemented as a variety of computing devices, such as a laptop computer, a desktop computer, a notebook, a workstation, a mainframe computer, a server, and the like. In one implementation, the stationary device 206 may be implemented as a variety of computing devices, such as a laptop computer, a desktop computer, a notebook, and the like, enabled to communicate with the communication device 100 using the NFC protocol, the Bluetooth protocol, or the device contact application. In another implementation, the stationary device 206 may be implemented as an ultrasound beacon or a QR code enabled device.

In one implementation, the device management system 202 includes one or more processor(s) 210-1, I/O interface(s) 212-1, and a memory 214-1 coupled to the processor 210. Further, the stationary device 206 includes processor(s) 210-2, I/O interface(s) 212-2, and a memory 214-2 coupled to the processor 210-2.

The processors, 210-1 and 210-2, hereinafter collectively referred to as the processors 210 and individually referred to as the processor 210, can be a single processing unit or a number of units, all of which could also include multiple computing units. The processors 210 may be implemented as one or more microprocessors, microcomputers, microcontrollers, digital signal processors, central processing units, state machines, logic circuitries, and/or any devices that manipulate signals based on operational instructions. Among other capabilities, the processors 210 are configured to fetch and execute computer-readable instructions and data stored in the memory 214-1 and 214-2, hereinafter collectively referred to as the memory 214.

The functions of the various elements shown in the figures, including any functional blocks labeled as “processor(s)”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, network processor, application specific integrated circuit (ASIC), field programmable gate array (FPGA), read only memory (ROM) for storing software, random access memory (RAM), and non volatile storage. Other hardware, conventional and/or custom, may also be included.

Each of the I/O interfaces 212-1 and the I/O interfaces 212-2, hereinafter collectively referred to as the I/O interface 212, may include a variety of software and hardware interfaces, for example, interface for peripheral device(s), such as a keyboard and an external memory. Further, the I/O interfaces 212 may enable the device management system 202 and the stationary device 206 to communicate with other network entities, such as the communication device 100.

The memory 214 may include any computer-readable medium known in the art including, for example, volatile memory, such as static random access memory (SRAM) and dynamic random access memory (DRAM), and/or non-volatile memory, such as read only memory (ROM), erasable programmable ROM, and flash memories.

In one implementation, the device management system 202 includes modules 216 and data 218. The modules 216, amongst other things, include routines, programs, objects, components, data structures, etc., which perform particular tasks or implement particular abstract data types. The modules 216 may also be implemented as, signal processor(s), state machine(s), logic circuitries, and/or any other device or component that manipulate signals based on operational instructions.

Further, the modules 216 can be implemented in hardware, instructions executed by a processing unit, or by a combination thereof. The processing unit can comprise a computer, a processor, such as the processor 210-1, a state machine, a logic array, or any other suitable devices capable of processing instructions. The processing unit can be a general-purpose processor which executes instructions to cause the general-purpose processor to perform the required tasks or, the processing unit can be dedicated to perform the required functions.

In another aspect of the present subject matter, the modules 216 may be machine-readable instructions (software) which, when executed by a processor/processing unit, perform any of the described functionalities. The machine-readable instructions may be stored on an electronic memory device, hard disk, optical disk or other machine-readable storage medium or non-transitory medium. In one implementation, the machine-readable instructions can be also be downloaded to the storage medium via a network connection.

The modules 216 further include a policy determination module 220, a system interaction module 222, and other modules 224. The other module(s) 224 may include programs or coded instructions that supplement applications and functions of the device management system 202.

The data 218, amongst other things, serves as a repository for storing data processed, received, associated, and generated by one or more of the module(s) 216. The data 218 includes, for example, device policy data 226, system data 228, and other data 230. The other data 230 includes data generated as a result of the execution of one or more modules in the other module(s) 224.

Further, the stationary device 206 includes modules 232 and data 234. The modules 232, amongst other things, include routines, programs, objects, components, data structures, etc., which perform particular tasks or implement particular abstract data types. The modules 232 may also be implemented as, signal processor(s), state machine(s), logic circuitries, and/or any other device or component that manipulate signals based on operational instructions.

Further, the modules 232 can be implemented in hardware, instructions executed by a processing unit, or by a combination thereof. The processing unit can comprise a computer, a processor, such as the processor 210-2, a state machine, a logic array, or any other suitable devices capable of processing instructions. The processing unit can be a general-purpose processor which executes instructions to cause the general-purpose processor to perform the required tasks or, the processing unit can be dedicated to perform the required functions.

In another aspect of the present subject matter, the modules 232 may be machine-readable instructions (software) which, when executed by a processor/processing unit, perform any of the described functionalities. The machine-readable instructions may be stored on an electronic memory device, hard disk, optical disk or other machine-readable storage medium or non-transitory medium. In one implementation, the machine-readable instructions can be also be downloaded to the storage medium via a network connection.

The module(s) 232 further includes a location identifier module 236 and other module(s) 238. The other module(s) 238 may include programs or coded instructions that supplement applications and functions of the stationary device 206. The data 234, amongst other things, serves as a repository for storing data processed, received, associated, and generated by one or more of the module(s) 232. The data 234 further includes location data 240 and other data 242.

As previously described, the device management system 202 is configured to provide the device management policies to the communication device 100 based upon the location coordinates determined by the stationary device 206. In one implementation, the stationary device 206 may be placed at the predetermined location where the device management policy are to be implemented in the communication device 100 for restricting one or more of the capabilities of the communication device 100. For example, the stationary device may be placed at an entrance of a research lab of an organization where the camera of the communication device 100 is to be disabled based on the device management policy. A user of the communication device 100, say, the employee of the organization while entering the research lab, may thus initially bring the communication device 100 in contact with the stationary device 206, say, an NFC enabled device.

Upon coming in contact with the stationary device 206, the interaction module 112 of the communication device 100 may communicate with the stationary device 206 over the short range communication link 208 using the NFC protocol. In one embodiment, the interaction module 112 may exchange an interaction message with the location identifier module 236. The interaction module 112 and the location identifier module 236 may exchange with each other the interaction message having their respective device identification details, such as an IP address to allow initiation of data transfer between them. Upon exchange of the interaction message, the location identifier module 236 may determine the location coordinates of the communication device 100. For instance, upon receiving the interaction message from the communication device 100, the location identifier module 236 may ascertain that the communication device 100 is in its vicinity and may thus have the same location coordinates as the stationary device 206. The location identifier module 236 may thus obtain the location coordinates of the stationary device 206 from the location data 240 and provide the same to the interaction module 112 over the short range communication link 208 using, for example, the NFC protocol.

Similarly, in case of the stationary device 206 being a Bluetooth enabled device, the location identifier module 236 may provide the location coordinates over the short range communication link 208 using the Bluetooth protocol. For instance, upon receiving the interaction message from the communication device 100, the location identifier module 236 may ascertain that the communication device 100 is in its vicinity and may thus have the same location coordinates as the stationary device 206. The location identifier module 236 may thus obtain the location coordinates of the stationary device 206 from the location data 240 and provide the location coordinates over the short range communication link 208 using the Bluetooth protocol.

Further, in case of the stationary device 206 being an ultrasound beacon, the location identifier module 236 may identify the location coordinates of the communication device 100 using the ultrasound technique and provide the location coordinates to communication device 100 as sound codes over the short range communication link 208 using the ultrasound technique.

Furthermore, in case of the stationary device 206 being enabled to communicate using the device contact application, the contact between the communication device 100 and the stationary device 206 may be a physical contact with the user touching the communication device 100 with the stationary device 206. Upon completion of the device contact action, the location identifier module 236 may determine the location coordinates of the communication device 100 and provide the location coordinates to the communication device 100 over the short range communication link 208 using the device contact application protocols. For instance, upon receiving the interaction message from the communication device 100, the location identifier module 236 may ascertain that the communication device 100 is in its vicinity and may thus have the same location coordinates as the station device 206. The location identifier module 236 may thus obtain the location coordinates of the stationary device 206 from the location data 240 and provide the location coordinates over the short range communication link 208 using the device contact application protocol.

Additionally, in case of the stationary device 206 being a QR code enabled device, the contact may include the communication device 100 scanning the QR code. The interaction module 112 may include a scanning application for communicating with the stationary device 206 by scanning the QR code to obtain, as the interaction message, a scanned image of the QR code. The policy implementation module 114 may subsequently use the scanned image to decode the QR codes for determining the device management policies.

The interaction module 112 may subsequently provide the location coordinates to the device management system 202 over the communication network 204. In one implementation, the system interaction module 222 may be configured to receive the location coordinates from the interaction module 112. The system interaction module 222 may further save the location coordinates in the system data 228. The policy determination module 220 may subsequently determine the device management policy corresponding to the location coordinates. For the purpose, the policy determination module 220 may obtain the location coordinates from the system data 228 and determine the predetermined location corresponding to the location coordinate. Based on the predetermined location, the policy determination module 220 may determine the device management policy corresponding to the predetermined location from among a plurality of device management policies saved in the device policy data 226.

The system interaction module 222 may provide the device management policy, thus identified, to the communication device 100 over the communication network 204. The policy implementation, module 114 may subsequently implement the device management policy to restrict few capabilities, say, the camera of the communication device 100 in accordance with the device management policy. Further, as previously described, the policy implementation module 114 may remove the restrictions on the capabilities while moving out of the predetermined location, for example, upon a communication between the interaction module 112 and the stationary device 206.

FIG. 3 illustrates a network environment 300 implementing the communication device 100 in communication with the stationary device configured to function as the device management system, in accordance with the second embodiment of the present subject matter. In said embodiment, a stationary device 302, configured to function as the device management system 202, communicates with the communication device 100 over the short range communication link 208 using the short range communication protocols, such as the NFC, the Bluetooth, and the device contact application. In said embodiment, the stationary device 302 is positioned at the predetermined location where the device management policy are to be implemented in the communication device 100 for restricting one or more of the capabilities of the communication device 100. The stationary device 302 is configured to provide the device management policies to the communication device 100, upon the communication device 100 entering the predetermined location, using the short range communication protocols, such as the NFC, the Bluetooth, and the device contact application.

In one implementation, the stationary device 302 may be implemented as a variety of computing devices, such as a laptop computer, a desktop computer, a notebook, and the like enabled to communicate with the communication device 100 using the NFC protocol, the Bluetooth protocol, or the device contact application. In one implementation, the stationary device 302 may be an NFC enabled device. In another implementation, the stationary device 302 may be a Bluetooth enabled device. In yet another implementation, the stationary device 302 may be a device contact application enabled device.

In one implementation, the stationary device 302, functioning as the device management system includes the processor(s) 210-1, the I/O interface(s) 212-1, and the memory 214-1 coupled to the processor 210. In one implementation, the stationary device 302 includes the modules 216 and the data 218. The modules 216 further include the policy determination module 220, the system interaction module 222, and the other modules 224. The data 218 includes, for example, the device policy data 226, the system data 228, and the other data 230.

As previously described, the stationary device 302, functioning as the device management system may be stationed at the predetermined location such that the user intending to enter the predetermined location may initially bring the communication device 100 in contact with the stationary device 302. Upon coming in contact with the stationary device 302, the interaction module 112 of the communication device 100 may communicate with the stationary device 302 over the short range communication link 208 using the short range communication protocol. In one embodiment, the interaction module 112 may communicate by exchanging the interaction message with the system interaction module 222. The interaction message, as aforementioned may include the device identification details. Upon exchange of the interaction message, the policy determination module 220 may ascertain that the communication device 100 is in its vicinity and has same location coordinates as the stationary device.

Based on the ascertaining, the policy determination module 220 may obtain the device management policy associated with the location coordinates. In one implementation, the policy determination module 220 may access the device policy data 226 to obtain the device management policy associated with the predetermined location corresponding to the location coordinates from among a plurality of device management policies saved in the device policy data 226. The device management policy, thus obtained, may be transmitted to the communication device 100 by the system interaction module 222 over the short range communication link 208 using the short communication protocol, such as the NFC protocol and the Bluetooth protocol.

For instance, in case of the stationary device 302 being an NFC enabled device, the system interaction module 222 provide the device management policy to the communication device 100 using the NFC protocol. Similarly, in case of the stationary device 302 being a Bluetooth enabled device, the system interaction module 222 provide the device management policy to the over the short range communication link 208 using the Bluetooth protocol.

Further, in case of the stationary device 302 being enabled to communicate using the device contact application, the system interaction module 222 may provide the device management policy to the communication device 100 over the short range communication link 208 using the device contact application protocols. The policy implementation module 114 of the communication device 100 may subsequently implement the device management policy to restrict few capabilities, say, the camera of the communication device 100 in accordance with the device management policy. Further, as previously described, the policy implementation module 114 may remove the restrictions on the capabilities while moving out of the predetermined location, for example, upon a communication between the interaction module 112 and the stationary device 302.

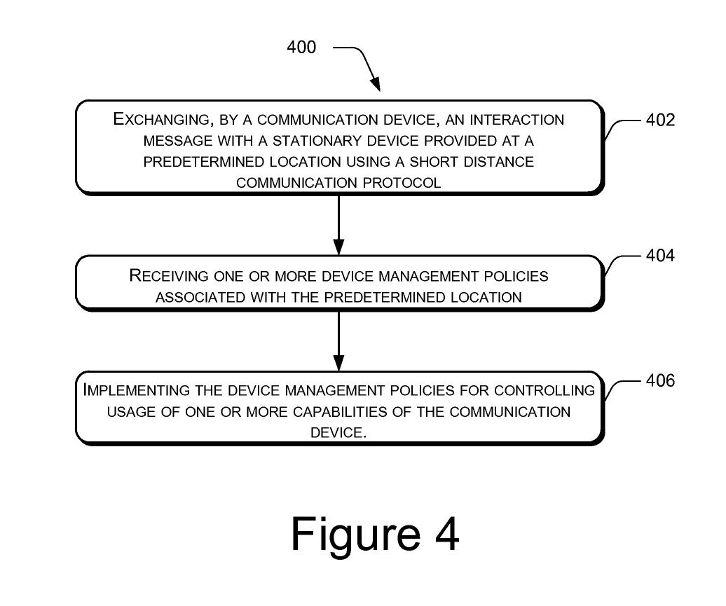

FIG. 4 illustrates a method 400 for implementing device managing policies for managing capabilities of a communication device 100, in accordance with an embodiment of the present subject matter. The order in which the method is described is not intended to be construed as a limitation, and any number of the described method blocks can be combined in any order to implement the method 400 or any alternative methods. Additionally, individual blocks may be deleted from the methods without departing from the spirit and scope of the subject matter described herein. Furthermore, the method(s) can be implemented in any suitable hardware, software, firmware, or combination thereof.

The method(s) may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

A person skilled in the art will readily recognize that steps of the method(s) can be performed by programmed computers. Herein, some embodiments are also intended to cover program storage devices, for example, digital data storage media, which are machine or computer readable and encode machine-executable or computer-executable programs of instructions, where said instructions perform some or all of the steps of the described method. The program storage devices may be, for example, digital memories, magnetic storage media, such as a magnetic disks and magnetic tapes, hard drives, or optically readable digital data storage media. The embodiments are also intended to cover both communication network and communication devices configured to perform said steps of the exemplary method(s).

At block 402, a communication device communicates with a stationary device provided at a predetermined location using a short distance communication protocol. In one implementation, a user of the communication device, say, the communication device 100 while entering a predetermined location where certain capabilities of the communication device needs to be restricted may bring the communication device in contact with a stationary device, for example, the stationary device (206, 302) located at the predetermined location. For instance, the stationary device may be stationed at an entrance of the predetermined location, say, a conference room of an organization. Upon the contact, the communication device may communicate with the stationary device using one or more short range communication protocols, such as NFC, Bluetooth, ultrasound technology, device contact application, and QR code scanning technology. In a first embodiment, the communication device may communicate with the stationary device to receive location coordinates of the predetermined location. In a second embodiment, the communication device may communicate with the stationary device to receive one or more device management policies associated with the predetermined location. In a third embodiment, the communication may include scanning a QR code provided in the stationary device at the predetermined location.

At block 404, device management policies associated with the predetermined location are obtained. In a first embodiment, the communication device 100 may obtain the device management policies from a server functioning as a device management system, say, the device management system 202 communicating with the communication device 100 over a communication network. In one implementation, the communication device 100 may initially provide the location coordinates of the predetermined location, obtained from the stationary device 206, to the device management system 202. The device management system 202 may subsequently provide the device management policies associated with the predetermined location corresponding to the location coordinates to the communication device 100.

In a second embodiment, the device management policies maybe obtained from a stationary device, say, the stationary device 302 configured to function as the device management system 202 capable of interacting with the communication device 100 using the short range communication. The device management policies maybe obtained from the stationary device upon establishing of the communication between the communication device 100 and the stationary device 302.

At block 406, the device management policies are implemented for controlling usage of one or more capabilities of the communication device 100. In one implementation, the communication device 100 may implement the device management policies to restrict the capabilities while entering the predetermined location. Further, while moving out of the predetermined location, the communication device 100 may communicate with stationary device to remove the restrictions.

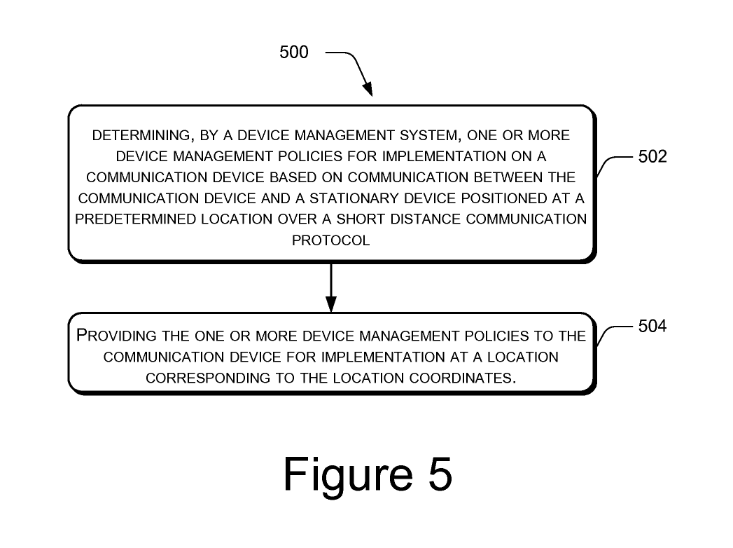

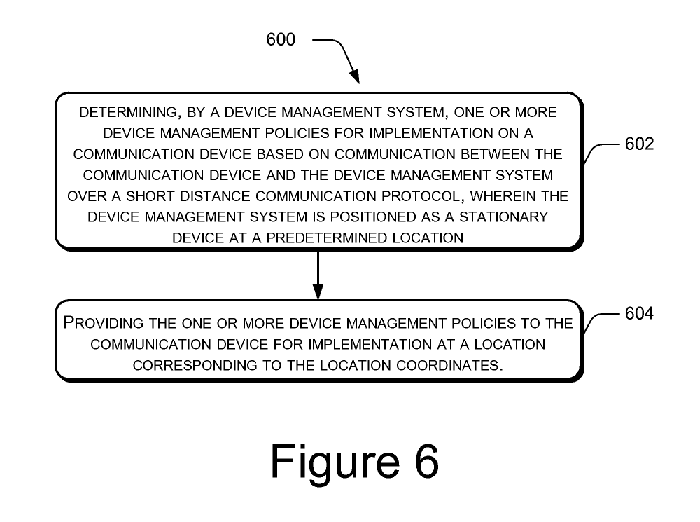

FIGS. 5 and 6 illustrate methods 500 and 600 for providing device managing policies to a communication device for managing capabilities of the communication device, in accordance with a first embodiment and a second embodiment, respectively, of the present subject matter. The order in which the method is described is not intended to be construed as a limitation, and any number of the described method blocks can be combined in any order to implement the methods 500 and 600 or any alternative methods. Additionally, individual blocks may be deleted from the methods without departing from the spirit and scope of the subject matter described herein. Furthermore, the method(s) can be implemented in any suitable hardware, software, firmware, or combination thereof.

The method(s) may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

A person skilled in the art will readily recognize that steps of the method(s) can be performed by programmed computers. Herein, some embodiments are also intended to cover program storage devices, for example, digital data storage media, which are machine or computer readable and encode machine-executable or computer-executable programs of instructions, where said instructions perform some or all of the steps of the described method. The program storage devices may be, for example, digital memories, magnetic storage media, such as a magnetic disks and magnetic tapes, hard drives, or optically readable digital data storage media. The embodiments are also intended to cover both communication network and communication devices configured to perform said steps of the exemplary method(s).

FIG. 5 illustrates the method 500 for providing device managing policies to a communication device for managing capabilities of the communication device, in accordance with the first embodiment of the present subject matter.

At block 502, device management policies are determined for implementation on a communication device. In one implementation, the device management policies are determined based on communication between the communication device and a stationary device positioned at a predetermined location over a short distance communication protocol. For instance, the communication device may communicate with the stationary device to obtain location coordinates of the predetermined location. The location coordinates, thus obtained, are provided to a server functioning as a device management system over a communication network, such as a wireless network.

At block 504, the device management policies are provided to the communication device for implementation at the predetermined location. In one implementation, the device management system 202 may provide the device management policies to the communication device 100 over the communication network.

FIG. 6 illustrates the method 600 for providing device managing policies to a communication device for managing capabilities of the communication device, in accordance with the second embodiment of the present subject matter.

At block 602, device management policies are determined for implementation on a communication device. In one implementation, the device management policies are determined based on communication between the communication device and the device management system over a short distance communication protocol. In said embodiment, the device management system 202 is positioned as a stationary device 302 at a predetermined location. For instance, the stationary device 302 may be a device enabled to communicate with the communication device 100 using anyone of the NFC protocol, the Bluetooth protocol, and device contact application protocol. In said, embodiment, the stationary device 302 may determine upon the communication that the communication device 100 is in vicinity of the stationary device 302 and may thus determine the device management policies associated with predetermined location.

At block 604, the device management policies are provided to the communication device for implementation at the predetermined location. In one implementation, the stationary device 302 may provide the device management policies to the communication device 100 over the short range communication link 208 using the short range communication protocol.

Although embodiments for managing capabilities of a communication device are described have been described in a language specific to structural features and/or method(s), it is to be understood that the invention is not necessarily limited to the specific features or method(s) described. Rather, the specific features and methods are disclosed as exemplary embodiments for managing capabilities of a communication device.

I/We claim:

1. A method for managing capabilities of a communication device, the method comprising:
communicating by a communication device, with a stationary device provided at a predetermined location using a short distance communication protocol;
obtaining one or more device management policies associated with the predetermined location; and
implementing the device management policies for controlling usage of one or more capabilities of the communication device at the predetermined location.

2. The method as claimed in claim 1, wherein the communicating comprises scanning a quick response (QR) code of the stationary device for obtaining a scanned image of the QR code.

3. The method as claimed in claim 1, wherein the communicating comprises receiving, from the stationary device, location coordinates of the predetermined location.

4. The method as claimed in claim 1, wherein the short distance communication protocol is at least one of a near field communication (NFC) protocol, an ultrasound protocol, a Bluetooth protocol, and a device contact action protocol.

5. A method for managing capabilities of a communication device, the method comprising:
determining, by a device management system, one or more device management policies for implementation on a communication device based on a short distance communication protocol based communication between the communication device and a stationary device positioned at a predetermined location; and
providing the one or more device management policies to the communication device for implementation at the predetermined location.

6. The method as claimed in claim 5, wherein the short distance communication protocol is at least one of a near field communication (NFC) protocol, an ultrasound protocol, a Bluetooth protocol, and a device contact action protocol.

7. The method as claimed in claim 5 further comprising receiving location coordinates of the predetermined location from the communication device.

8. The method as claimed in claim 5 further comprising identifying the one or more device management policies from among a plurality of device management policies based on the location coordinates of the predetermined location.

9. A method for managing capabilities of a communication device, the method comprising:
determining, by a stationary device, one or more device management policies for implementation on a communication device based on communication between the communication device and the device management system over a short distance communication protocol, wherein the stationary device is configured to function as a device management system at a predetermined location; and
providing the one or more device management policies to the communication device for implementation at the predetermined location.

10. The method as claimed in claim 9, wherein the short distance communication protocol is at least one of a near field communication (NFC) protocol, a Bluetooth protocol, and a device contact action protocol.

11. The method as claimed in claim 9 further comprising:
exchanging an interaction message with the communication device, wherein the interaction message includes device identification details; and
ascertaining the communication device to be in vicinity of the stationary device to determine location coordinates of the communication device to be same as the stationary device.

12. A stationary device comprising:
a processor;
a policy determination module coupled to the processor, the policy determination module configured to determine one or more device management policies for implementation on a communication device based on communication between the communication device and the stationary device over a short distance communication protocol, wherein the stationary device is configured to function as a device management system positioned at a predetermined location; and
a system interaction module coupled to the processor, the system interaction module configured to provide the one or more device management policies to the communication device for implementation at the predetermined location.

13. The stationary device as claimed in claim 12, wherein the short distance communication protocol is at least one of a near field communication (NFC) protocol, a Bluetooth protocol, and a device contact action protocol.

14. A device management system comprising:
a processor;
a policy determination module coupled to the processor, the policy determination module configured to determine one or more device management policies for implementation on a communication device based on communication between the communication device and a stationary device positioned at a predetermined location over a short distance communication protocol; and
a system interaction module coupled to the processor, the system interaction module configured to provide the one or more device management policies to the communication device for implementation at the predetermined location.

15. The device management system as claimed in claim 14, wherein the short distance communication protocol is at least one of a near field communication (NFC) protocol, an ultrasound protocol, a Bluetooth protocol, and a device contact action protocol.

16. The device management system as claimed in claim 14, wherein the policy determination module is further configured to identify the one or more device management policies from among a plurality of device management policies based on the location coordinates of the predetermined location.

17. A communication device comprising:
a processor;
an interaction module coupled to the processor, the interaction module configured to scan a quick response (QR) code to obtain a scanned image of a QR code; and
a policy implementation module coupled to the processor, the policy implementation module configured to:
decode the scanned image for determining one or more device management policies; and
implement the one or more device management policies for controlling usage of one or more capabilities of the communication device.
